(19) United States
(12) Patent Application Publication
(10) Pub. No.: US 2025/0041775 A1
(43) Pub. Date: Feb. 6, 2025

(54) WATER RECOVERY SYSTEMS AND METHODS

(71) Applicant: FLOW ENVIRONMENTAL CORP., Innisfail (CA)

(72) Inventors: Steve WIDMER, Red Deer County (CA); Terry McGEOUGH, Lacombe County (CA); Jacob THORKMAN, Bowden (CA)

(73) Assignee: FLOW ENVIRONMENTAL CORP., Innisfail (CA)

(21) Appl. No.: 18/516,688

(22) Filed: Nov. 21, 2023

Related U.S. Application Data
(60) Provisional application No. 63/529,883, filed on Jul. 31, 2023.

(51) Int. Cl. B01D 36/04; B01D 21/00; B01D 21/24; B01D 21/26; B01D 33/01; B01D 33/067; B01D 33/11; B01D 33/72; B08B 3/02; C02F 9/00

(52) U.S. Cl. CPC B01D 36/045; B01D 21/0009; B01D 21/2461; B01D 21/267; B01D 33/015; B01D 33/067; B01D 33/11; B01D 33/72; B08B 3/022; C02F 9/00; C02F 1/004; C02F 2001/007; C02F 1/32; C02F 1/38; C02F 1/48; C02F 11/121; C02F 2303/04

(57) ABSTRACT

Systems and methods for recovering clarified water and by-products from hydrovac waste or other slurry waste include a receiving unit for receiving the waste; a processing unit for separating coarse aggregates, fine aggregates, and raw water within the waste; and a water clarifying unit for removing ultrafine suspended solids and solid particles from the raw water to yield clarified water.

### CROSS-REFERENCE TO RELATED APPLICATION

This application claims priority to U.S. Provisional Patent Application No. 63/529,883, filed Jul. 31, 2023, which is incorporated herein by reference in its entirety.

### FIELD OF THE INVENTION

The present invention is directed to systems and methods for recovering clarified water and by-products from hydrovac waste or other slurry waste.

### BACKGROUND OF THE INVENTION

Hydrovacs are hydro excavation trucks which use a combination of high-pressure water and a powerful vacuum to excavate soil on site and immediately remove it by placing it into the debris tank of the truck. Hydrovacs are commonly used for daylighting, soil trenching, debris removal, piling hole excavation, and cold weather digging, thereby enabling the location and exposure of existing underground infrastructure or the installation of new underground infrastructure. Hydrovacs reduce the risk of damaging existing underground utilities and can minimize ground surface disturbances.

However, hydro excavation results in “hydrovac waste,” commonly defined as a slurry waste created in the sub-surface soil excavation process. The resulting slurry waste generally comprises about 60% water and 40% solids. Slurry waste may also include hazardous substances such as, for example, heavy metals, oils, gasoline, solvents, etc. Consequently, this by-product requires detailed analysis (i.e., flashpoint, pH, leachable metals, leachable solvents, etc.), proper management, and stringent disposal procedures. Disposal options are currently limited to off-site options (e.g., authorized waste management facility) or on-site options (e.g., centrifugation or phase separation). Slurry waste cannot be applied to land without robust analysis and strict authorization. Commonly multiple storage bins, berms, and pits are used to hold the slurry waste until it dries, or the slurry waste is spread out on drying beds. However, such methods require multiple storage units or large areas, and drying can be hampered by rain or snow.

Accordingly, there is a need for improved systems and methods of hydrovac waste management which recycle, reuse, or repurpose hydrovac waste into non-hazardous value-added products for various applications, and obviate these problems associated with hydrovac waste management.

### SUMMARY OF THE INVENTION

The present invention relates to systems and methods for recovering clarified water and by-products from hydrovac waste or other slurry waste.

In a first aspect, the invention comprises a system for recovering clarified water and by-products from hydrovac waste or other slurry waste comprising:
a receiving unit for receiving the waste;
a processing unit for separating coarse aggregates, fine aggregates, and raw water within the waste; and
a water clarifying unit for removing ultrafine suspended solids and solid particles from the raw water to yield clarified water.

In some embodiments, the receiving unit comprises a tank comprising opposing inclined sides and a bottom defining a trough for receiving the waste. In some embodiments, a pair of jetted waterlines are positioned on the opposing sides and along a length of the tank for dispensing water to wash the waste. In some embodiments, an auger is disposed within the trough to transfer the waste from the receiving unit to the processing unit.

In some embodiments, the processing unit comprises a rotary drum screen comprising an inlet, a rotatable perforated cylindrical drum, flighting within the drum, a plurality of mesh screens, and a plurality of wash bars, and an outlet. In some embodiments, oversized material exits through the outlet onto a cross conveyor for removal. In some embodiments, the oversized material comprises coarse aggregates.

In some embodiments, undersized fine material passes through the plurality of mesh screens into a collection tank for pumping through a first set of hydro-cyclones for removing the fine aggregates from the water. In some embodiments, underflow material from the first set of hydro-cyclones is deposited onto a de-watering shaker screen for separating a first portion of water for recycling and a second portion of water for clarification, the second portion of water being transferred to the water clarifying unit for removing the ultrafine suspended solids and the solid particles to yield the clarified water.

In some embodiments, the second portion of water is pumped through a second set of hydro-cyclones for removing the ultrafine suspended solids from the water, the water being treated and clarified in a clarifier tank. In some embodiments, the clarifier tank comprises one or more sediment removing devices, magnets, UV sterilizers, augers, or a combination thereof to remove the solid particles.

In a second aspect, the invention comprises a method for recovering clarified water and by-products from hydrovac waste or other slurry waste using the above system. The method comprises:
unloading the waste from a hydrovac truck into the receiving unit configured for receiving the waste;
transferring the washed waste to the processing unit for separating coarse aggregates, fine aggregates, and raw water within the waste; and
transferring the raw water to the water clarifying unit for removing the ultrafine suspended solids and the solid particles from the raw water to yield the clarified water.

In some embodiments, the method further comprises dispensing water through a pair of jetted waterlines positioned in the receiving unit to wash the waste, and transferring the washed waste to the processing unit using an auger disposed within the receiving unit.

In some embodiments, the method further comprises washing and separating undersized materials having a predetermined maximum size from oversized materials using correspondingly sized mesh screens of a rotary drum screen.

In some embodiments, the method further comprises depositing the oversized material from the rotary drum screen onto a cross conveyor for removal, the oversized material comprising the coarse aggregates.

In some embodiments, the method further comprises washing, collecting, and pumping the undersized material through a first set of hydro-cyclones for removing the fine aggregates from wash water.

In some embodiments, the method further comprises depositing underflow material from the first set of hydro-cyclones onto a de-watering shaker screen, separating a first portion of water for recycling and a second portion of water for clarification, and transferring the second portion of water to the water clarifying unit for removing the ultrafine suspended solids and the solid particles to yield the clarified water.

In some embodiments, the method further comprises pumping the second portion of water through a second set of hydro-cyclones, removing the ultrafine suspended solids from the water, and treating and clarifying the water in a clarifier tank.

In some embodiments, the method further comprises removing the solid particles from the water using one or more sediment removing devices, magnets, UV sterilizers, augers, or a combination thereof.

Additional aspects and advantages of the present invention will be apparent in view of the description, which follows. It should be understood, however, that the detailed description and the specific examples, while indicating preferred embodiments of the invention, are given by way of illustration only, since various changes and modifications within the scope of the invention will become apparent to those skilled in the art from this detailed description.

### BRIEF DESCRIPTION OF THE DRAWINGS

The invention will now be described by way of an exemplary embodiment with reference to the accompanying simplified, diagrammatic, not-to-scale drawings. In the drawings:

FIG. 1 is a perspective view of a first embodiment of a water recovery system of the present invention.

FIGS. 2A-E are views of a material receiving unit of the system of FIG. 1. FIG. 2A is a top perspective view. FIG. 2B is a side perspective view. FIGS. 2C-D are left and right side end perspective views. FIG. 2E is a side cross-sectional view, taken along line A-A in FIG. 2A.

FIGS. 3A-G are views of a material processing unit of the system of FIG. 1. FIGS. 3A-B are left and right side perspective views. FIG. 3C is a top perspective view. FIG. 3D is a front side perspective view. FIGS. 3E-F are left and right side end perspective views. FIG. 3G is a back side perspective view.

FIGS. 4A-E are views of a rotary drum screen of the material processing unit of FIG. 3A. FIG. 4A is a top perspective view. FIG. 4B is a side perspective view. FIGS. 4C-D are left and right side end perspective views. FIG. 4E is a side cross-sectional view, taken along line A-A in FIG. 4A.

FIGS. 5A-I are views of a water clarifying unit of the system of FIG. 1. FIGS. 5A-B are left and right side perspective views. FIG. 5C is a top perspective view. FIG. 5D is a front side perspective view. FIGS. 5E-F are left and right side end perspective views. FIG. 5G is a back side perspective view. FIG. 5H is a side cross-sectional view, taken along line A-A in FIG. 5G. FIG. 5I is a side cross-sectional view, taken along line B-B in FIG. 5C.

FIG. 6 is a schematic diagram of a top view of the material processing unit and the water clarifying unit, showing a plumbing system including water spray/guns, suction lines, and discharge lines.

FIGS. 7A-B are perspective views of a second embodiment of a water recovery system of the present invention. FIG. 7C is a cross-sectional side view of the water recovery system of FIGS. 7A-B.

FIGS. 8-13 show results of a Computational Fluid Dynamics (CFD) study of the water flow analysis inside a clarifier tank comprising lamella or tube settlers of the present invention.

FIG. 14 is a flow diagram showing steps of a method for recovering clarified water and by-products from hydrovac waste using the water recovery systems of the present invention.

### DETAILED DESCRIPTION OF PREFERRED EMBODIMENTS

Before the present invention is described in further detail, it is to be understood that the invention is not limited to the particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. As used herein and in the appended claims, the singular forms “a,” “an,” and “the” include plural referents unless the context clearly dictates otherwise. In addition, the components and steps described in the above embodiments and figures are merely illustrative and do not imply that any particular component or step is a requirement of a claimed embodiment.

The present invention comprises systems and methods for recovering clarified water and by-products from hydrovac waste or other slurry waste. As used herein, the term “hydrovac waste” refers to slurry waste created in the sub-surface soil excavation process. The resulting slurry waste generally comprises about 60% raw water and 40% solids. As used herein, the term “raw water” refers to untreated water including, but not limited to, groundwater, rainwater, water from streams, lakes, and rivers, hydrovac excavation wastewater, and the like. As used herein, the term “clarified water” refers to water which has undergone a sequence of operations used to remove suspended solid (mineral and organic) and solid particles. As used herein, the term “by-products” refers to secondary products which are derived from the sequence of operations used to obtain the primary product.

The invention generally provides multi-component systems and multi-step methods which remediate the hydrovac waste or other slurry waste into non-hazardous value-added products. In some embodiments, the systems and methods remediate the hydrovac waste or other slurry waste into clarified water as the primary product, and coarse aggregates, fine aggregates, and ultrafine suspended solids as the by-products. As used herein, the term “aggregate” refers to inert granular material. As used herein, the term “coarse aggregate” refers to particles having a diameter greater than about 1.8 inches (3.175 mm). As used herein, the term “fine aggregate” refers to particles having a diameter less than about 1.8 inches (3.175 mm). As used herein, the term “ultrafine” refers to particles of nanoscale size or having a diameter less than about 100 nm. Clarified water may be reused in various industrial processes. Coarse aggregates including, but not limited to rock and sand, may be used as construction materials. Fine aggregates (i.e., stackable solids) may be used as landscaping or ground fill material. Ultrafines are collected in paste form and can be used as a site top fill or landfill top fill once dried.

In some embodiments, the invention remediates the hydrovac waste or other slurry waste into clarified water and by-products at an accelerated rate compared to conventional systems and methods. In some embodiments, the rate is about 3.5 m³ per minute for the whole process. However, it will be appreciated by those skilled in the art that there may be different flow rates within the individual systems onboard, and which may fluctuate depending on the operator and the material being processed.

In one aspect, the invention comprises a system for recovering clarified water and by-products from hydrovac waste or other slurry waste comprising: a receiving unit for receiving the waste; a processing unit for separating coarse aggregates, fine aggregates, and raw water within the waste; and a water clarifying unit for removing ultrafine suspended solids and solid particles from the raw water to yield clarified water.

Although the invention is described in the context of processing slurry waste obtained from hydro excavation, it will be appreciated by those skilled in the art that the invention may also be suitable for processing slurry waste generated from processes other than hydro excavation. The invention may be used to process a wide variety of slurry wastes other than hydrovac waste.

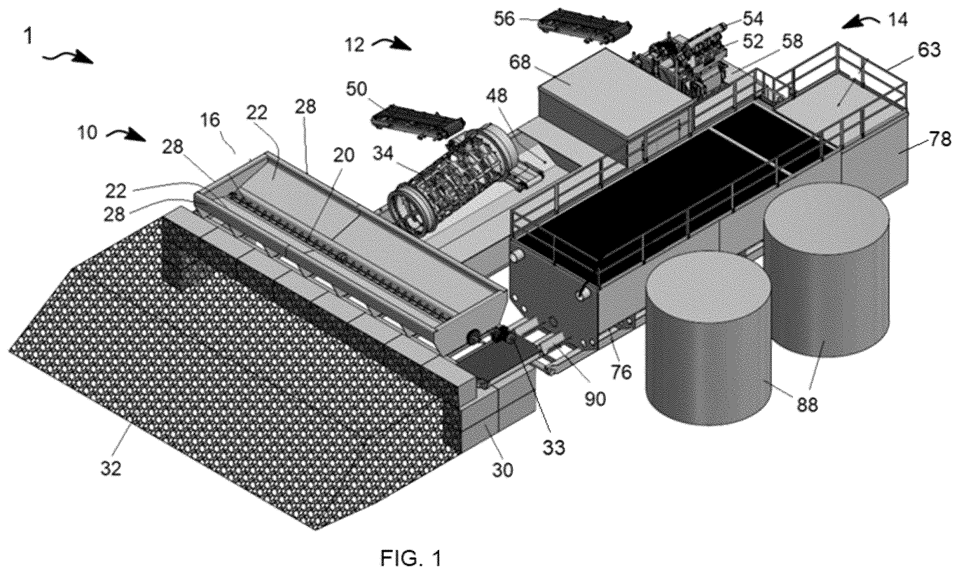

The invention will now be described having reference to the accompanying Figures. In a first embodiment, the system (1) is shown generally in FIG. 1 to include three distinct units, namely a material receiving unit (10) for receiving slurry waste from a hydrovac, a material processing unit (12) for separating coarse aggregates, fine aggregates, and raw water within the slurry waste, and a water clarifying unit (14) for removing ultrafine suspended solids and solid particles from the raw water to yield clarified water. Each unit (10, 12, 14) comprises various components which intercommunicate to perform selected functions, as will be further described.

### Material Receiving Unit

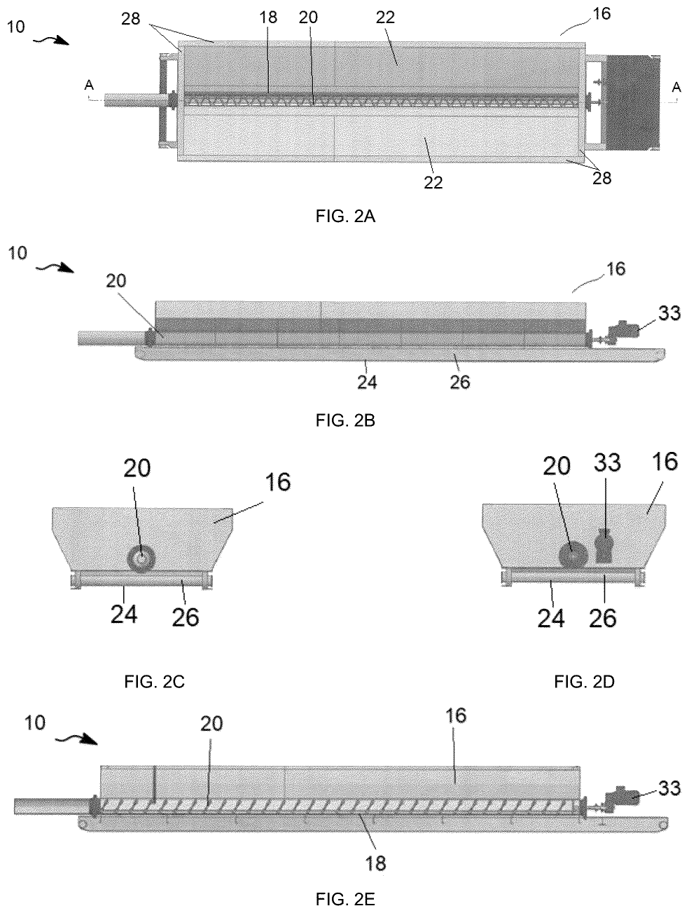

FIGS. 2A-E are views of one embodiment of a material receiving unit (10) of the system (1) for receiving and storing slurry waste which is unloaded from a hydrovac, truck, or other equipment. In some embodiments, the slurry waste is unloaded from a hydrovac, truck, or other equipment within an existing process. In some embodiments, the material receiving unit (10) generally comprises a tank (16), a pair of jetted waterlines (18), and an auger (20).

The tank (16) is configured to receive slurry waste unloaded from the hydrovac, truck or other equipment, and to introduce the slurry waste into the material processing unit (12). In some embodiments, the tank (16) comprises an uncovered open top to facilitate the unloading of the slurry waste from the hydrovac truck or other equipment. In some embodiments, the tank (16) comprises a live bottom tank. In some embodiments, the tank (16) comprises opposing sides (22) and a bottom (24). The opposing sides (22) slope inwardly toward one another from top to bottom, with the opposing sides (22) and bottom (24) of the tank (16) forming a trough (26) for receiving the slurry waste. In some embodiments, the tank (16) further comprises side wall splash guards (28) to prevent spillage of the slurry waste outside of the tank (16).

In some embodiments, the tank (16) is generally rectangular-shaped. In some embodiments, the tank (16) has a length of about 30 feet and a width of about 10 feet. In some embodiments, the tank (16) has a capacity of about 15 cubic meters. Although the tank (16) is shown in the Figures as having a generally rectangular-shape, the particular size, shape, and type of tank are not limitations of the invention. In some embodiments, the tank (16) is mounted on a heavy-duty skid (30) comprising I-beams which frame and support the skid (30). In some embodiments, the skid (30) is positioned adjacent a ramp (32) for allowing the hydrovacs, trucks, or other equipment to approach the tank (16) mounted on the skid (30) to unload the slurry waste into the tank (16).

In some embodiments, a pair of jetted waterlines (18) are positioned on the opposing sides (22) and along the length of the tank (16). The jetted waterlines (18) dispense water from a clarifier tank (76) to wash the slurry waste as it enters the tank (16) and is directed by the sloped opposing sides (22) of the tank (16) into the tank bottom (24) where the auger (20) moves the slurry waste from within the material receiving unit (10) to the material processing unit (12). In some embodiments, the water for washing the slurry water comprises recycled water.

In some embodiments, the auger (20) is disposed within the trough (26) to run along the length of the tank bottom (24). In some embodiments, the auger (20) comprises a shaftless screw transfer auger. In some embodiments, the auger (20) has a diameter ranging from about 12 inches to about 36 inches, depending on the material being introduced. A driver and transmission (33) is coupled to the auger (20) to permit rotation of the auger (20) in a desired direction at a desired rotational speed. In some embodiments, the rotational speed ranges from about 0 to 22 RPM. In some embodiments, the driver and transmission (33) comprises a 20 HP helical gear drive. Rotation of the auger (20) moves the slurry waste generally along the axis of the auger (20) either laterally or in an elevated manner from within the material receiving unit (10) to the material processing unit (12). It is contemplated that other propulsion means other than the auger (20) may be used to transfer the slurry waste from the material receiving unit (10) to the material processing unit (12).

### Material Processing Unit

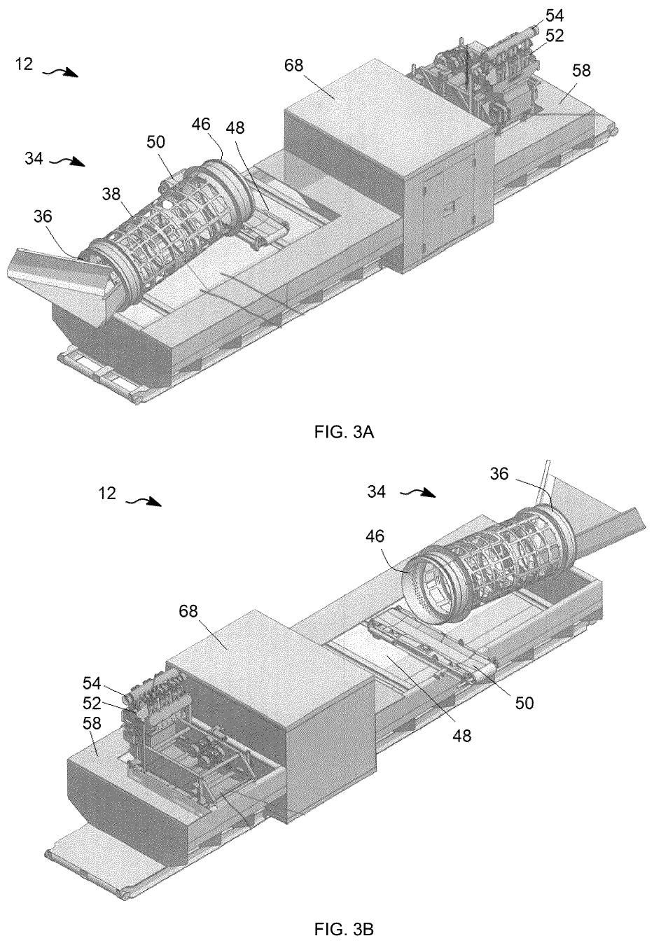

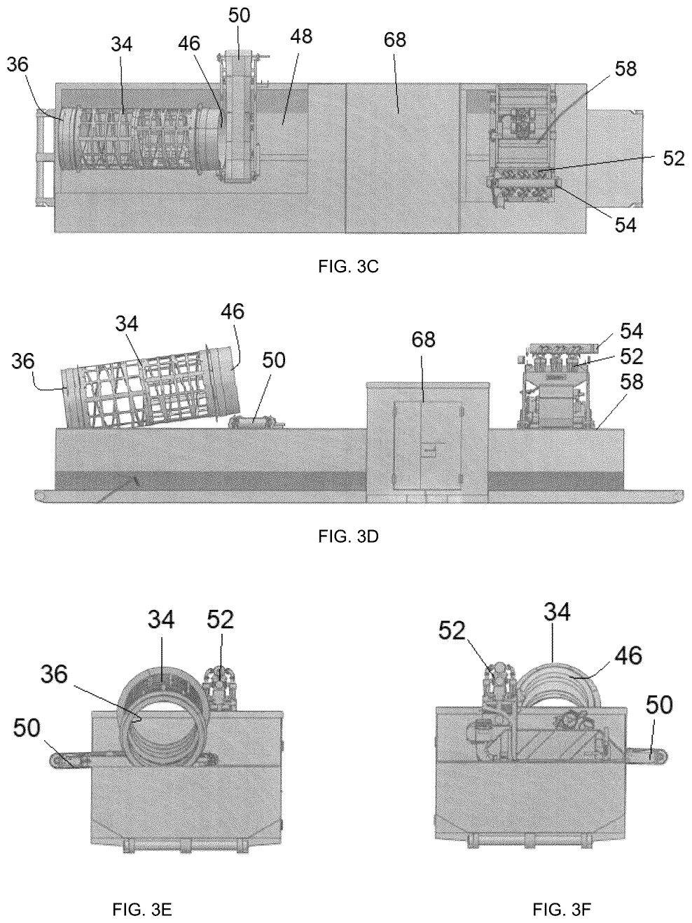

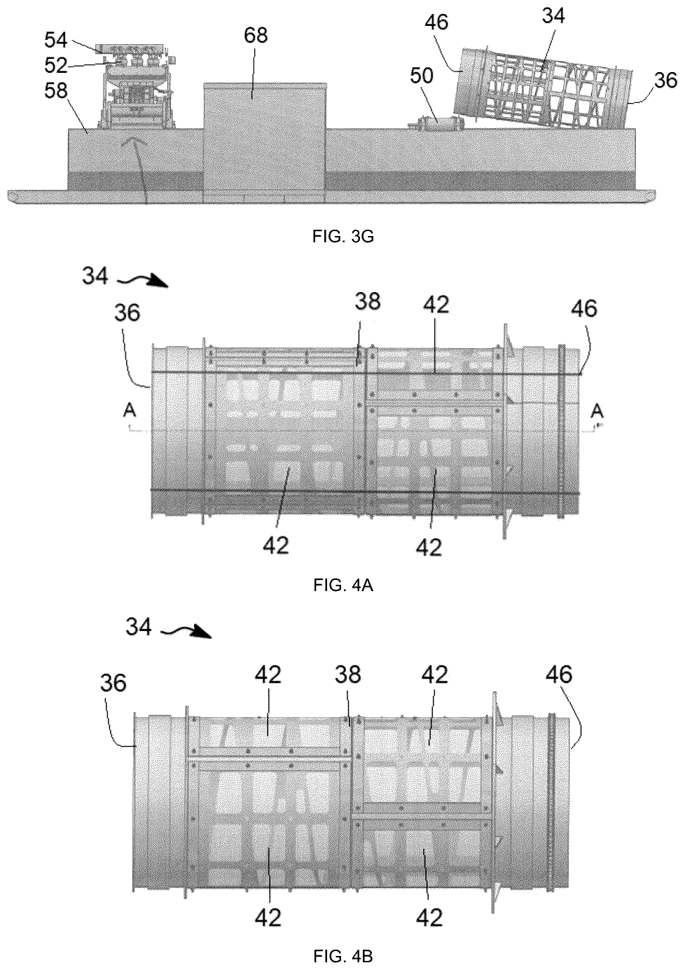

FIGS. 3A-G are views of a material processing unit (12) of the system (1) for processing the slurry waste received from the material receiving unit (10). The material processing unit (12) generally comprises a rotary drum screen (34), a collection tank (48), a cross conveyor (50), a first set of de-sanding hydro-cyclones (52), a de-watering shaker screen (54), a conveyor (56), and a shaker tank (58).

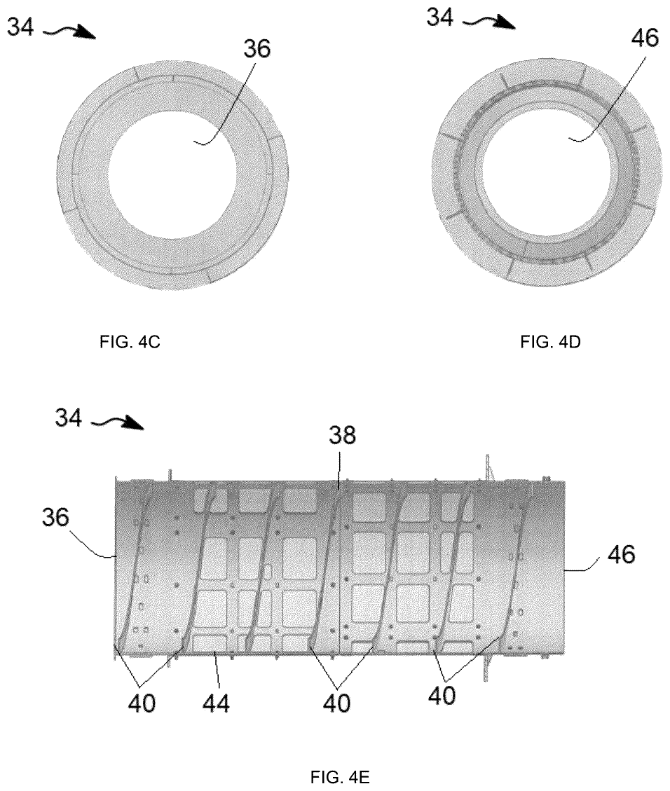

The slurry waste is transferred by the auger (20) into the rotary drum screen (34). As shown in FIGS. 4A-E, the rotary drum screen (34) generally comprises an inlet (36) through which the slurry waste enters from the auger (20); a rotatable perforated cylindrical drum (38) which spirals the slurry waste; flighting (40) for advancing the slurry waste through the drum (38); a plurality of mesh screens (42) for filtering the slurry waste; a plurality of wash bars (44) positioned along the length of the drum (38) for dispensing water to wash the material; and an outlet (46) allowing exit of oversized materials.

In some embodiments, the rotary drum screen (34) is mounted upwardly or inclined an at angle relative to a collection tank (48) positioned beneath the rotary drum screen (34) (FIGS. 3D and 3G). In some embodiments, the angle ranges from about 0 to about 6 degrees. In some embodiments, the angle of the rotary drum screen (34) is adjustable by an operator to control the flow of slurry waste passing therethrough. In some embodiments, the rotary drum screen (34) is powered by a variable frequency drive (“VFD”), allowing the operator to regulate the speed at which the rotary drum screen (34) rotates. In some embodiments, the speed ranges from about 12 to about 19 RPM.

Physical size separation is achieved as the slurry waste is advanced by the flighting (40) in an upward direction along the length of the drum (38) (FIG. 4E). In some embodiments, the rotary drum screen (34) separates materials having a predetermined maximum size from larger materials within the slurry waste through correspondingly sized mesh screens (42). In some embodiments, the mesh screens (42) are sized to filter materials having a maximum size of about ⅛ inches or about 3.175 mm from larger materials within the slurry waste. In some embodiments, the mesh screens (42) are sized to filter materials having a size ranging from about 3/32 inches to about 3/16 inches from larger materials within the slurry waste.

Oversized material which is larger than the mesh screens (42) is washed by water dispensed from the wash bars (44) as it moves along the drum (38) and exits through the outlet (46). The oversized material is deposited onto a cross conveyor (50) and removed from the system (1). In some embodiments, the oversized material comprises coarse aggregates. In some embodiments, the coarse aggregates comprise gravel and rocks that can be sorted for road base or other building materials.

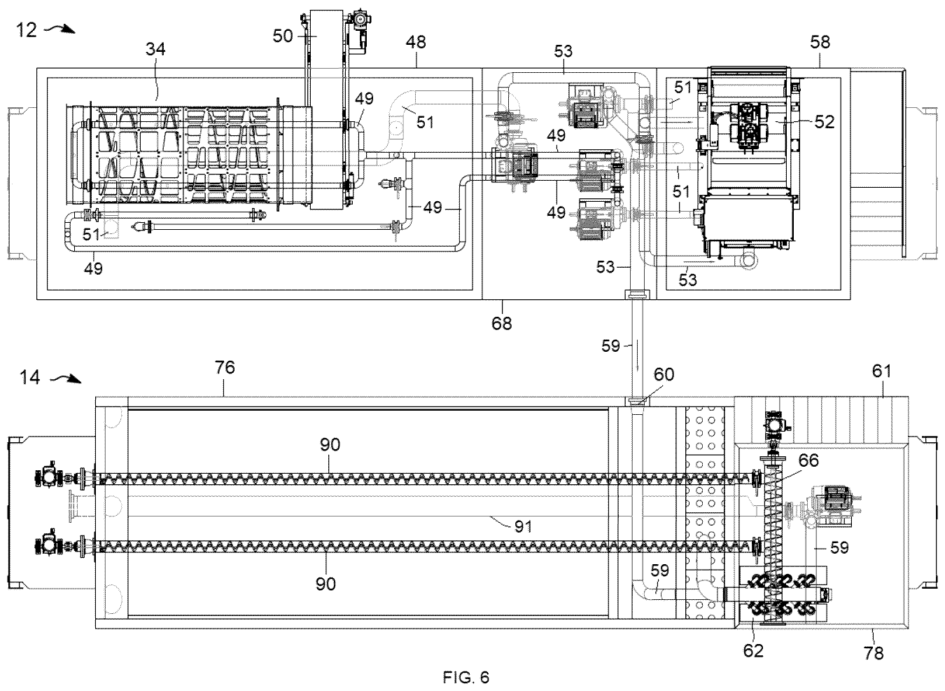

Undersized material which is smaller than the mesh screens (42) is washed by water dispensed from the wash bars (44) as it passes through the mesh screens (42) into the collection tank (48). In some embodiments, the undersized material comprises fine aggregates. In some embodiments, water is dispensed through a water spray system or water guns (49) (FIG. 6). In some embodiments, the collection tank (48) comprises a downward slope to facilitate feeding of the mixture (i.e., the fine aggregates and water) into suction lines (51) for pumping the mixture through discharge lines (53) and through a first set of hydro-cyclones (52) (FIG. 6). In some embodiments, mud guns and agitators (not shown) maintain the mixture of fine aggregates and water, facilitating its pumping through the first set of hydro-cyclones (52) for removing the fine aggregates from the water. In some embodiments, the hydro-cyclones (52) comprise de-sanding hydro-cyclones.

As used herein, the term “hydrocyclone” refers to a vessel which uses fluid pressure to generate centrifugal force and a flow pattern which can separate particles from a liquid medium based on different densities. The hydrocyclone comprises a cylindrical chamber connected to a conical body which leads to the bottom outlet at the apex of the cone. This discharges the “underflow.” The reverse flow is located by a pipe which projects axially into the top of the chamber and discharges the “overflow.”

In some embodiments, the underflow material (i.e., the fine aggregates) is deposited onto a de-watering shaker screen (54). In some embodiments, the de-watering shaker (54) may be a 4-panel shaker. The de-watering shaker (54) uses rotational G-force to advance the fine aggregates for removal using a conveyor (56) or other suitable removal means. The fine aggregates (i.e., stackable solids) may be used as landscaping or ground fill material.

In some embodiments, the overflow material (i.e., water) flows through the de-watering shaker (54) into a shaker tank (58). A portion of the water from the shaker tank (58) may be used as wash water for the rotary screen drum (34). The remaining water (i.e., turbid or muddy water) is pumped through a discharge pipe (59) and through a shear point valve (60) for mixing with an additive to yield a 100% homogenous solution before being pumped to the water clarifying unit (14) (FIG. 6). In some embodiments, the pump house (68) may be heated. In some embodiments, the pump house (68) houses electric drives for the augers. In some embodiments, the shear point valve (60) may be installed in line with the discharge pipe (59) leading from the material processing unit (12) to the clarifier tank (76). In some embodiments, the shear point valve (60) comprises female NPT threads to be married to pipe on either side of it.

### Water Clarifying Unit

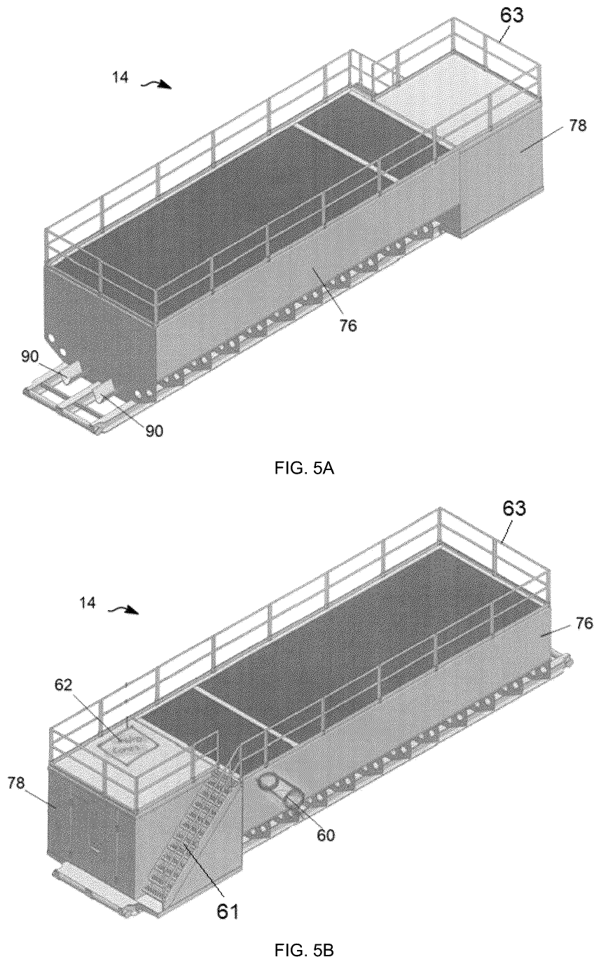

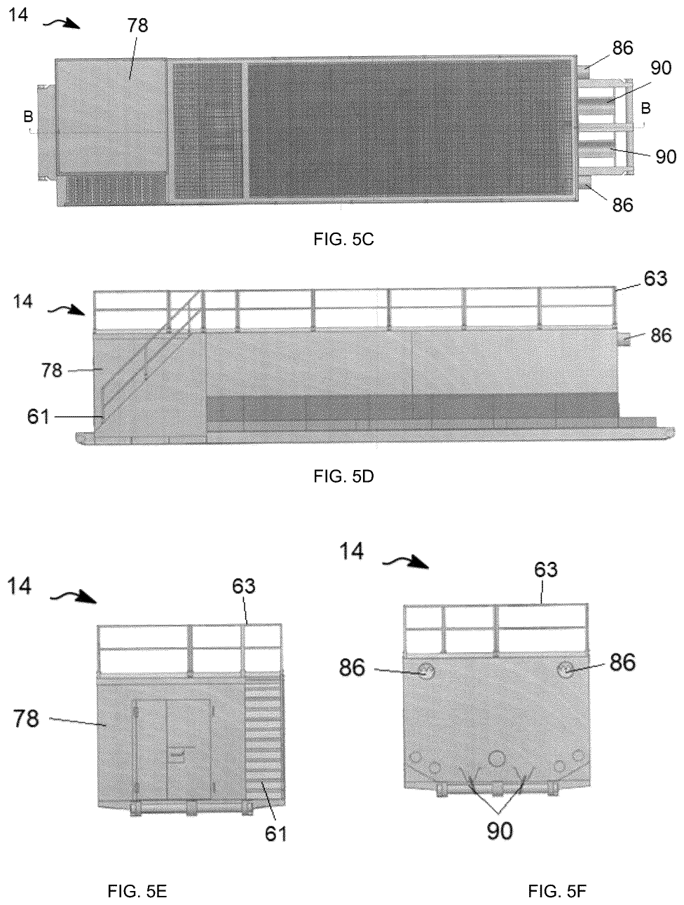

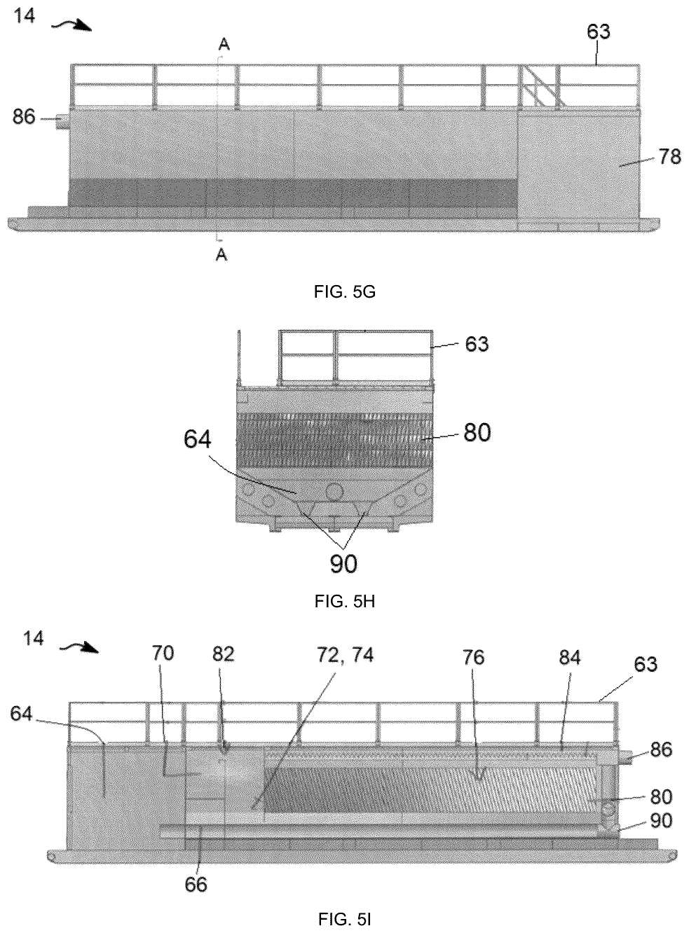

FIGS. 5A-I are views of a water clarifying unit (14) of the system (1) for clarifying the turbid water using engineered flow dynamics to remove the ultrafine suspended solids to yield clarified water. In some embodiments, the water clarifying unit (14) is generally rectangular-shaped. In some embodiments, the water clarifying unit (14) has a length of about 48 ft, a width of about 12 feet, and a height of about 12.5 ft. Although the water clarifying unit (14) is shown in the Figures as having a generally rectangular-shape, the particular size, shape, and type of water clarifying unit are not limitations of the invention. The water clarifying unit (14) generally comprises multiple components including hydro-cyclones, augers, and tanks, as will be further described. In some embodiments, the water clarifying unit (14) includes a staircase (61) and safety barriers (63) including, but not limited to guardrails, handrails, walkways, and platforms, to allow an operator to safely access the water clarifying unit (14) from above for monitoring the water clarifying process below, and maintaining and repairing components thereof.

The turbid water from the material processing unit (12) is pumped through a second set of hydro-cyclones (62) for removing the ultrafine suspended solids from the turbid water. In some embodiments, the underflow material (i.e., the ultrafine suspended solids) is deposited into a collection hopper (64) (FIG. 5H). In some embodiments, the collection hopper (64) is positioned below the hydro-cyclones (62) and above unloading or solids transfer cross-augers (66). In some embodiments, the unloading cross-augers (66) comprise augers with helical gear drives.

In some embodiments, the overflow material (i.e., water) flows into a diffuser tank (70) which aerates (i.e., transfers air and with that oxygen) into the water. Oxygen is required by microorganisms or bacteria resident in the water to break down any pollutants. Depending on the type of diffuser tank, coarse or fine bubbles are generated in the water.

In some embodiments, the aerated water may be treated with one or more additives to reduce the water's ability to retain sediment. The aerated water flows over a first diffuser weir (72) and a second diffuser weir (74). The weirs (72, 74) create turbulence to boost the mixing of the aerated water with the one or more additives before entering a clarifier tank (76) (FIG. 5I).

In some embodiments, the one or more additives may be dispensed manually or automatically using a metered chemical injection pump (not shown) under a Programmable Logic Controller (“PLC”) (not shown) housed in a control room (78). In some embodiments, a PLC controls the functions of the system (1), performs datalogging, and communicates with any site master controller. The PLC may allow monitoring and trending of system process conditions. The PLC may be integrated into a Supervisory Control and Data Acquisition (“SCADA”) system which allows for remote operation and monitoring of the system (1) and emits alerts in the event of a fault. In some embodiments, the system (1) may be operated manually without the use of a PLC system.

In some embodiments, the clarifier tank (76) comprises sediment removing devices (80) for facilitating the settlement of solids at the bottom of the clarifier tank (76). In some embodiments, the sediment removing devices (80) comprise lamella or tube settlers which run from side to side and end to end of the clarifier tank (76). In some embodiments, the lamella or tube settlers have a depth of about 4 ft. Water entering the clarifier tank (76) is diverted through the lamella or tube settlers, ensuring complete solids separation.

In some embodiments, high-powered magnets (position indicated by reference numeral 82) are provided to trap metallic materials, preventing them from entering the clarifier tank (76). In some embodiments, the water clarifying unit (14) comprises high-powered UV sterilizers (position indicated by reference numeral 84) for sterilizing the water.

The resulting clarified water flows out of the clarifier tank (76) into a clarified water trough (86) comprising alligator teeth to impede the flow, facilitating additional cleaning. The clarified water is pumped from the trough (86) via a suitable pump including, but not limited to, a centrifugal pump (not shown) into storage tanks (88) (FIG. 1) for re-use to re-fill the hydrovacs or to be reintroduced into the system (1).

In some embodiments, the water clarifying unit (14) comprises solids transfer augers (90) positioned at the bottom of the clarifier tank (76) (FIGS. 5H-I). In some embodiments, the solids transfer augers (90) comprise flared trough augers. In some embodiments, the solids transfer augers (90) comprise a pair of flared trough augers with helical gear drives. The augers (90) are activated when the solids have settled or accumulated to a predetermined depth. In some embodiments, the depth ranges from about 12 inches to about 36 inches. Depth can be monitored visually through a manual indicator or automatically using level indicators controlled by the PLC. When activated, the augers (90) remove the settled solids from the clarifier tank (76) and discharge them into the unloading cross-augers (66), allowing for solids removal and processing. In some embodiments, the solids may be further dewatered using filtration or mechanical presses or by mixing with dewatering chemical in a pug mill. The resulting dried solids are stackable and reusable. Any captured water can be pumped through suction lines (91) to the storage tanks (88), or reused by the hydrovacs or within the system (1).

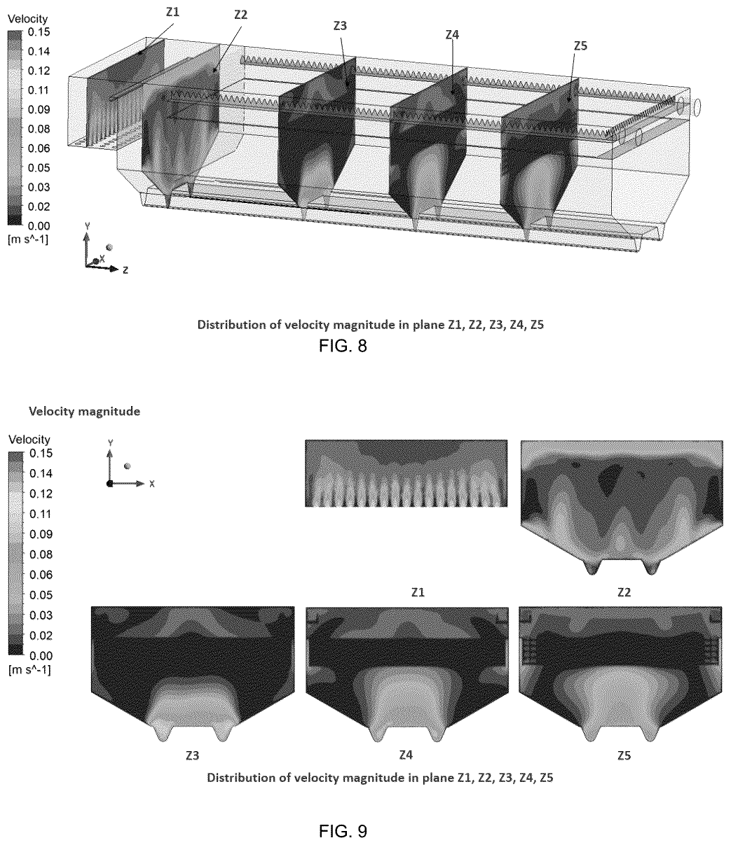

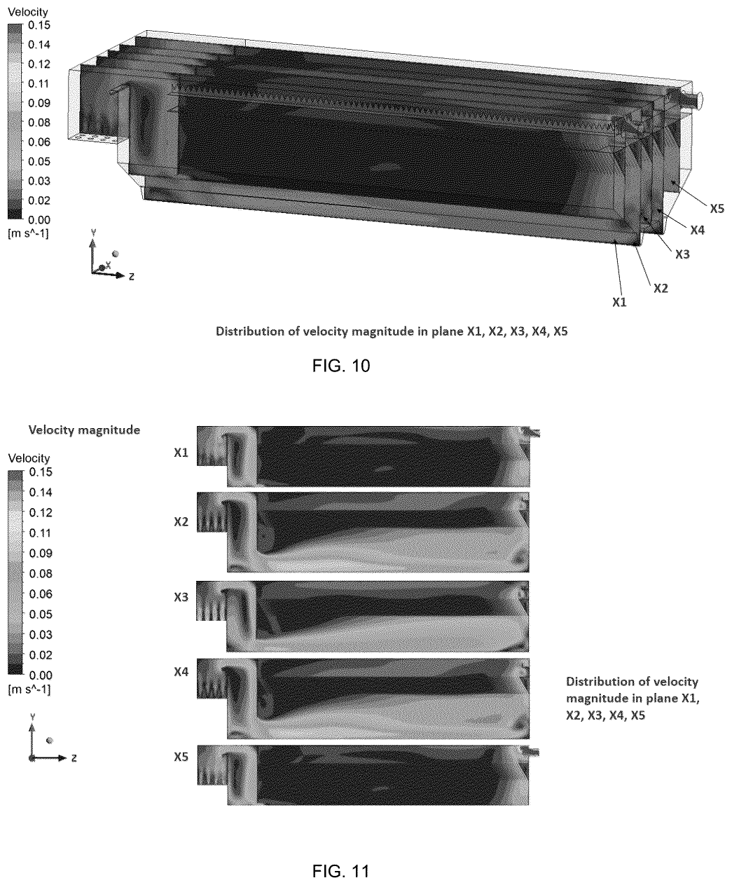

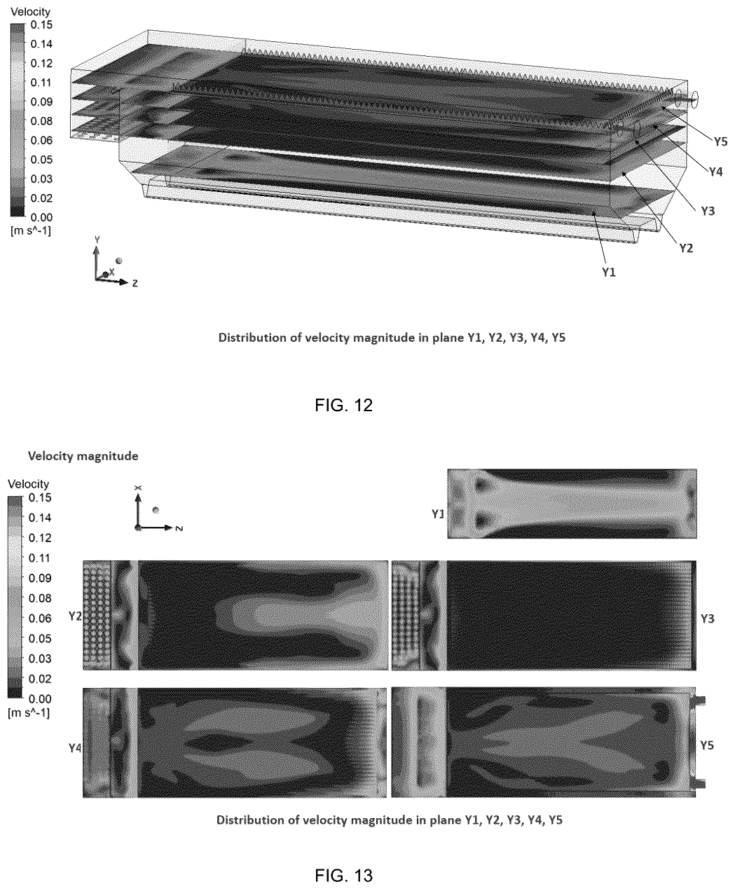

In some embodiments, the water clarification unit (14) provides accelerated clarification compared to convention clarification units, being capable of delivering up to about 1000 gallons (about 3.7 cubic meters) of clarified water per minute. In some embodiments, the water clarification unit (14) yields clarified water that is sufficiently clear of solids to be reused or released after a single treatment. FIGS. 8-13 show results of a Computational Fluid Dynamics (CFD) study of the water flow analysis inside the clarifier tank (76).

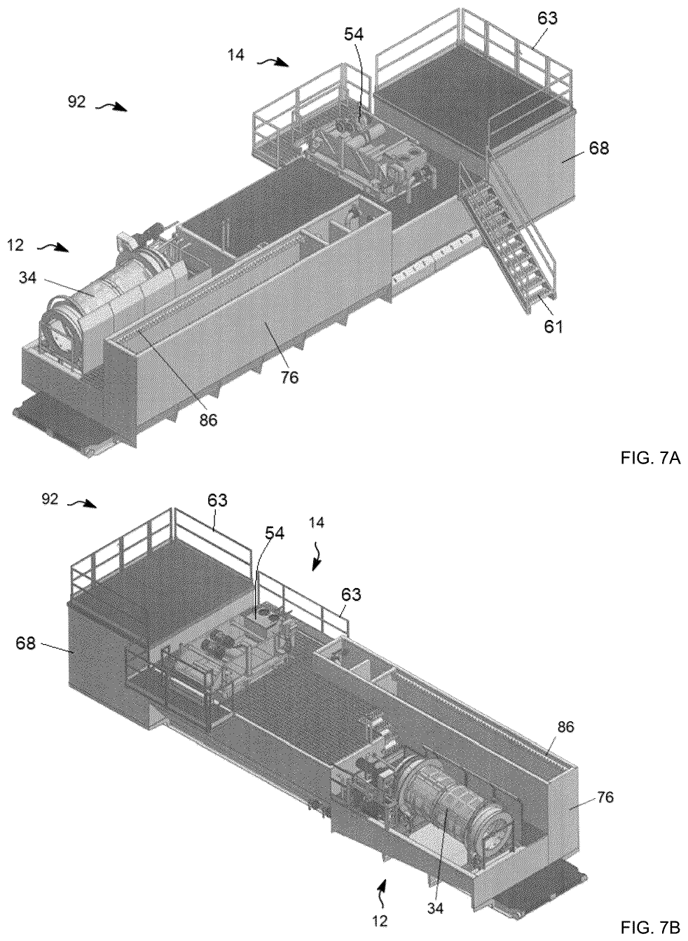

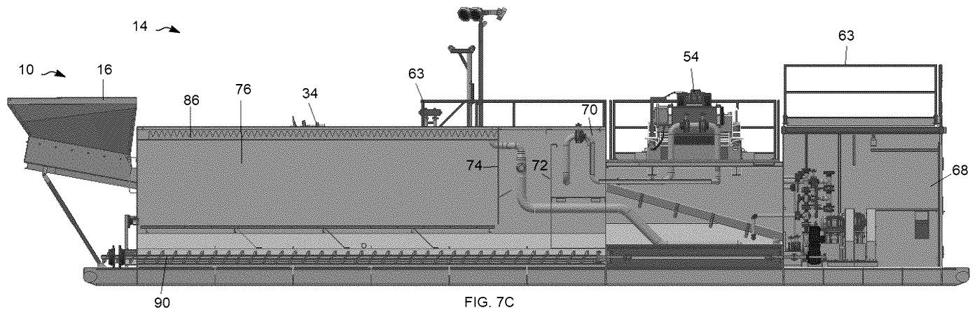

In some embodiments, the system (1) shown in FIG. 1 may be permanently installed on-site. In some embodiments shown in FIGS. 7A-C, the system (1) can be compactly designed and consolidated into a single skidded structure (92), making it highly transportable for relocation and suitable for installation in confined or tight locations where space may be limited. In some embodiments, the skidded structure (92) comprises the material receiving unit (10) in the form of a slurry tank, the material processing unit (12), and the water clarifying unit (14). Slurry waste is processed into coarse aggregates, fine aggregates, ultrafine suspended solids, and clarified water as described above. In some embodiments, about 60 cubic meters of slurry waste per hour can be processed. In some embodiments, about 6 to 10 hydrovac loads per hour can be processed.

In one aspect, the invention comprises a method for recovering clarified water and by-products from hydrovac waste using the systems of the present invention. The method comprises:
unloading the waste from a hydrovac truck into the receiving unit configured for receiving the waste;
transferring the washed waste to the processing unit for separating coarse aggregates, fine aggregates, and raw water within the waste; and
transferring the raw water to the water clarifying unit for removing the ultrafine suspended solids and the solid particles from the raw water to yield the clarified water.

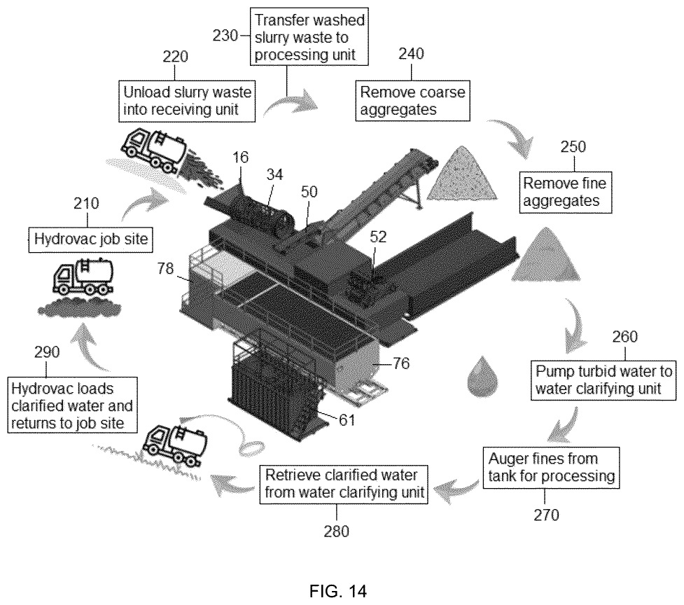

In some embodiments as shown in FIG. 14, the method comprises step 210 of a hydrovac truck at a job site where operators apply high-pressure water through a wand to break up the ground and suction the excess water and broken ground (i.e. the slurry waste) via a vacuum hose into the tank of the hydrovac truck. The hydrovac truck transports the collected slurry waste offsite to a remote disposal facility where the system (1) is located. At step 220, the hydrovac truck unloads the slurry waste into the tank (16) of the material receiving unit (10) where the slurry waste is then washed and transferred via the auger (20) to the material processing unit (12) at step 230.

At step 240, the slurry waste is transferred by the auger (20) into the rotary drum screen (34) for washing and separating materials having a predetermined maximum size from larger materials within the slurry waste through correspondingly sized mesh screens (42). The oversized material (i.e., coarse aggregates) which cannot pass through the mesh screens (42) are deposited on a cross conveyor (50) and removed from the system (1) for future use as road base or building materials.

At step 250, the undersized material (i.e., fine aggregates) which passes through the mesh screens (42) is washed by water and deposited into the collection tank (48). The mixture of fine aggregates and water is then pumped into the first set of hydro-cyclones (52) to remove the fine aggregates from the water for future use as landscaping or ground fill material.

At step 260, the water which is turbid or muddy is pumped to the water clarifying unit (14) where a second set of hydro-cyclones (62) remove the ultrafine suspended solids from the turbid water. The ultrafine suspended solids are deposited into a collection hopper (64) and unloaded or transferred via cross-augers (66) (step 270). The overflow material (i.e., water) flows through the de-watering shaker (54) into a shaker tank (58). A portion of the water from the shaker tank (58) may be used as wash water for the rotary screen drum (34). The remaining turbid water is pumped through a shear point valve (60) for mixing with an additive to yield a 100% homogenous solution before being pumped to the water clarifying unit (14).

At step 280, the resulting water is transferred to the clarifier tank (76) comprising sediment removing devices (80) in the form of lamella or tube settlers, ensuring complete solids separation. The resulting clarified water flows out of the clarifier tank (76) into a clarified water trough (86) comprising alligator teeth to impede the flow, facilitating additional cleaning. The clarified water is pumped from the trough (86) into storage tanks (88) for re-use to re-fill the hydrovacs (at step 290) which return to the job site, or to be reintroduced into the system (1).

According to embodiments disclosed herein, the present water recovery system and method recycle, reuse, and repurpose hydrovac waste or other slurry waste efficiently and safely, ultimately improving sustainability and minimizing damage to the environment. Since all material can be processed in real time at the live job site, foreign contamination on the job site may be avoided. In some embodiments, the system and method may accelerate water clarification and reduce hydrovac waste disposal service costs, as compared to conventional methods. Further, the system and method may ensure fewer trucks on the road, faster unload times, and quicker returns to the job site. There are cost savings from not having to drive to re-fill the hydrovac truck with water, and fuel savings for not having to drive the hydrovac truck to unload or re-fill with water.

The particular embodiments disclosed above are illustrative only, as the present disclosure may be modified and practiced in different but equivalent manners apparent to those skilled in the art having the benefit of the teachings herein. While numerous changes may be made by those skilled in the art, such changes are encompassed within the scope of the subject matter defined by the appended claims. Furthermore, no limitations are intended to the details of construction or design herein shown, other than as described in the claims below. It is therefore evident that the particular illustrative embodiments disclosed above may be altered or modified and all such variations are considered within the scope of the present disclosure.

What is claimed is:

1. A system for recovering clarified water and by-products from hydrovac waste or other slurry waste comprising:
a receiving unit for receiving the waste;
a processing unit for separating coarse aggregates, fine aggregates, and raw water within the waste; and
a water clarifying unit for removing ultrafine suspended solids and solid particles from the raw water to yield clarified water.

2. The system of claim 1, wherein the receiving unit comprises a tank comprising opposing inclined sides and a bottom defining a trough for receiving the waste.

3. The system of claim 2, wherein a pair of jetted waterlines are positioned on the opposing inclined sides and along a length of the tank for dispensing water to wash the waste.

4. The system of claim 3, wherein an auger is disposed within the trough to transfer the waste from the receiving unit to the processing unit.

5. The system of claim 1, wherein the processing unit comprises a rotary drum screen comprising an inlet, a rotatable perforated cylindrical drum, flighting within the drum, a plurality of mesh screens, and a plurality of wash bars, and an outlet.

6. The system of claim 5, wherein oversized material exits through the outlet onto a cross conveyor for removal, the oversized material comprising coarse aggregates.

7. The system of claim 6, wherein undersized fine material passes through the plurality of mesh screens into a collection tank for pumping through a first set of hydro-cyclones for removing the fine aggregates from wash water.

8. The system of claim 7, wherein underflow material from the first set of hydro-cyclones is deposited onto a de-watering shaker screen for separating a first portion of water for recycling and a second portion of water for clarification, the second portion of water being transferred to the water clarifying unit for removing the ultrafine suspended solids and the solid particles to yield the clarified water.

9. The system of claim 8, wherein the second portion of water is pumped through a second set of hydro-cyclones for removing the ultrafine suspended solids from the water, the water being treated and clarified in a clarifier tank.

10. The system of claim 9, wherein the clarifier tank comprises one or more sediment removing devices, magnets, UV sterilizers, augers, or a combination thereof to remove the solid particles.

11. A method for recovering clarified water and by-products from hydrovac waste or other slurry waste, the method comprising:
providing a system comprising:
a receiving unit for receiving the waste;
a processing unit for separating coarse aggregates, fine aggregates, and raw water within the waste; and
a water clarifying unit for removing ultrafine suspended solids and solid particles from the raw water to yield clarified water;
unloading the waste from a hydrovac truck into the receiving unit configured for receiving the waste;
transferring the washed waste to the processing unit for separating coarse aggregates, fine aggregates, and raw water within the waste; and
transferring the raw water to the water clarifying unit for removing the ultrafine suspended solids and the solid particles from the raw water to yield the clarified water.

12. The method of claim 11, further comprising dispensing water through a pair of jetted waterlines positioned in the receiving unit to wash the waste, and transferring the washed waste to the processing unit using an auger disposed within the receiving unit.

13. The method of claim 12, further comprising washing and separating undersized materials having a predetermined maximum size from oversized materials using correspondingly sized mesh screens of a rotary drum screen.

14. The method of claim 13, further comprising depositing the oversized material from the rotary drum screen onto a cross conveyor for removal, the oversized material comprising the coarse aggregates.

15. The method of claim 13, further comprising washing, collecting, and pumping the undersized material through a first set of hydro-cyclones for removing the fine aggregates from wash water.

16. The method of claim 15, further comprising depositing underflow material from the first set of hydro-cyclones onto a de-watering shaker screen, separating a first portion of water for recycling and a second portion of water for clarification, and transferring the second portion of water to the water clarifying unit for removing the ultrafine suspended solids and the solid particles to yield the clarified water.

17. The method of claim 16, further comprising pumping the second portion of water through a second set of hydro-cyclones, removing the ultrafine suspended solids from the water, and treating and clarifying the water in a clarifier tank.

18. The method of claim 17, further comprising removing the solid particles from the water using one or more sediment removing devices, magnets, UV sterilizers, augers, or a combination thereof.
